(19) United States
(12) Patent Application Publication
(10) Pub. No.: US 2026/0103378 A1
(43) Pub. Date: Apr. 16, 2026

(54) FACILITY AND METHOD FOR STORING HYDROGEN

(71) Applicant: SYNTHEC FUELS GMBH, Düsseldorf (DE)

(72) Inventor: Walter VANSELOW, Ratzeburg (DE)

(21) Appl. No.: 19/144,161

(22) PCT Filed: Dec. 29, 2023
(86) PCT No.: PCT/EP2023/088012

§ 371 Date: Jun. 27, 2025

(30) Foreign Application Priority Data
Dec. 30, 2022 (DE) 10 2022 135 057.6
Apr. 21, 2023 (DE) 10 2023 110 206.0

(51) Int. Cl. C01B 3/0015; C01B 3/14

(52) U.S. Cl. CPC C01B 3/0015; C01B 3/14; C01B 2203/0283; C01B 2203/0415; C01B 2203/0811; C01B 2210/0025

(57) ABSTRACT

A facility (100) for storing hydrogen in an organic liquid is disclosed. The facility (100) comprises an absorption chamber (190) adapted to hold the organic liquid, to receive synthesis gas such that the organic liquid sorbs the synthesis gas, separates the hydrogen from other components of the synthesis gas and bounds the hydrogen to store the hydrogen in the organic uid, and to release the other components of the synthesis gas from the organic liquid. Further, a method for storing hydrogen in an organic liquid is disclosed.

### TECHNICAL FIELD

The present disclosure relates to a facility for storing hydrogen in an organic liquid, such as a Liquid Organic Hydrogen Carrier (LOHC). Further, the present disclosure relates to a method for storing hydrogen in an organic liquid such as a Liquid Organic Hydrogen Carrier (LOHC). LOHC are organic compounds that can absorb and release hydrogen through chemical reactions.

### BACKGROUND OF THE INVENTION

Conventional techniques for producing hydrogen comprise producing a synthesis gas (also referred to as ‘Syngas’) from feedstock.

The feedstock may be biodegradable material that comprises a composition of carbon or carbohydrates containing substance, Hydrogen, Nitrogen, Calcium etc. The biodegradable material or biomass composition is generally found in organic materials like wood, plastic, pesticides, herbicides, pathogens, paints, contaminated solvents, residues from the paper and cellulose production, coal, tar, tar sand to name a few. This kind of feedstock is collected from homes, hospitals, power plants, oil refineries etc.

The synthesis gas comprises carbon monoxide CO and hydrogen H₂. The synthesis gas can be used in many applications including, but not limited to, running hydrogen engines. Sometimes, before use in an application, the hydrogen is stored.

Conventional techniques of storing hydrogen include extracting hydrogen from the synthesis gas by so-called Pressure Swing Adsorption (PSA). PSA is a process that separates a single element gas from a gas mixture. It is used in processes to extract hydrogen, H₂, from coke gas, for example, from a gas comprising hydrogen (H₂), methane (CH₄), carbon monoxide (CO), ethylene (C₂H₄). The coke gas may also comprise any one of benzene (C₆H₆), ammonia (NH₃), hydrogen sulfide (H₂S). According to the prior art, the hydrogen extracted by PSA is stored in an LOHC.

However, the existing techniques to store hydrogen have drawbacks as they are complex and involve many steps.

### OVERVIEW

The present invention aims to overcome the drawbacks of the conventional process for storing hydrogen in a Liquid Organic Hydrogen Carrier (LOHC). The various aspects of the present invention overcome drawbacks of the prior art. The following presents a simplified overview in order to provide a basic understanding of one or more aspects of the invention. This overview is not an extensive overview of the invention, and is intended neither to identify key or critical elements of the invention, nor to delineate the scope thereof. Rather, the primary purpose of the summary is to present some embodiments of the invention. [0008] In an aspect, the invention provides a facility for storing hydrogen in an organic liquid. The facility comprises an absorption chamber adapted to hold the organic liquid. The absorption chamber is further adapted to receive synthesis gas and have the synthesis gas contact the organic liquid in the absorption chamber. In some embodiments, the absorption chamber is adapted to have the synthesis gas contact the organic liquid by guiding the synthesis gas into the organic liquid. At least one effect can be that the organic liquid absorbs a portion of the synthesis gas, separates hydrogen from other components of absorbed synthesis gas and bounds separated hydrogen to store bound hydrogen in the organic liquid. The absorption chamber is still further adapted to release the other components of the synthesis gas from the organic liquid.

The facility can further comprise a reactor. The reactor is adapted to produce a hydrogen-rich synthesis gas by performing a Water-Gas Shift Reaction (WGSR) on synthesis gas. The absorption chamber is adapted to receive the hydrogen-rich synthesis gas from the reactor. The absorption chamber is adapted to hold an organic liquid. In some embodiments the absorption chamber is adapted to have the hydrogen-rich synthesis gas contact the organic liquid in the absorption chamber.

In some embodiments, the reactor is adapted to perform the WGSR on a combination of the synthesis gas and second steam to produce the hydrogen-rich synthesis gas.

In some embodiments, the facility further comprises a first endothermic chamber that is adapted to have feedstock perform endothermic break-down reactions to produce thermally-decomposed feedstock that can be used to produce the synthesis gas.

In some embodiments, the facility further comprises a second endothermic chamber that is adapted to produce the synthesis gas by performing an allothermal gasification process on a combination of the thermally-decomposed feedstock and first steam.

According to another aspect of the invention, a method for storing hydrogen in an organic liquid is provided. The method comprises providing the organic liquid and a synthesis gas comprising the hydrogen. The method further comprises having the organic liquid absorb at least a portion of the synthesis gas, separate hydrogen from other components of the absorbed synthesis gas and bound separated hydrogen to store the bound hydrogen in the organic liquid. The method further comprises releasing the other components of the synthesis gas from the organic liquid.

The method further comprises performing a Water-Gas Shift Reaction (WGSR) on synthesis gas to produce hydrogen-rich synthesis gas. The method further comprises bringing at least a portion of the hydrogen-rich synthesis gas into contact with the organic liquid.

In some embodiments, the WGSR is performed on a combination of the synthesis gas with second steam. In some embodiments, the method further comprises performing an endothermic reaction for thermal decomposition of feedstock to produce a pyrolysis product. The method further comprises performing an allothermal gasification process on the pyrolysis product to produce the synthesis gas. In some embodiments, the allothermal gasification process is performed on a combination of the pyrolysis product with first steam.

The independent claims define the invention in various aspects. The dependent claims state various embodiments according to the invention in the various aspects. Features of these embodiments may be combined with each other unless specifically noted to the contrary.

This overview is submitted with the understanding that it will not be used to interpret or limit the scope or meaning of the claims. This overview is not intended to identify key features or essential features of the claimed subject matter, nor is it intended to be used as an aid in determining the scope of the claimed subject matter. Those skilled in the art will recognize additional features and advantages upon reading the following detailed description, and upon viewing the accompanying drawings.

### BRIEF DESCRIPTION OF THE DRAWINGS

FIG. 1 is a drawing that schematically illustrates a facility for storing hydrogen in an organic liquid according to embodiments according to a first variant of the invention.

FIG. 2 is a drawing that schematically illustrates a facility for storing hydrogen in an organic liquid according to embodiments according to a second variant of the invention.

FIG. 3 is a flowchart that illustrates a method for storing hydrogen in an organic liquid according to an embodiment according to the invention in another aspect.

### DETAILED DESCRIPTION

Below, embodiments, implementations and associated effects are disclosed with reference to the drawing that illustrate views of some embodiments.

It should be noted that the view of exemplary embodiments are merely to illustrate selected features of some embodiments. As used herein, like terms refer to like elements throughout the description.

It is to be understood that the features of various embodiments described herein may be combined with each other, unless specifically noted otherwise. In some instances, well-known features are omitted or simplified to clarify the description of the exemplary implementations. The order in which the embodiments/implementations and methods/processes are described is not intended to be construed as a limitation, and any number of the described implementations and processes may be combined.

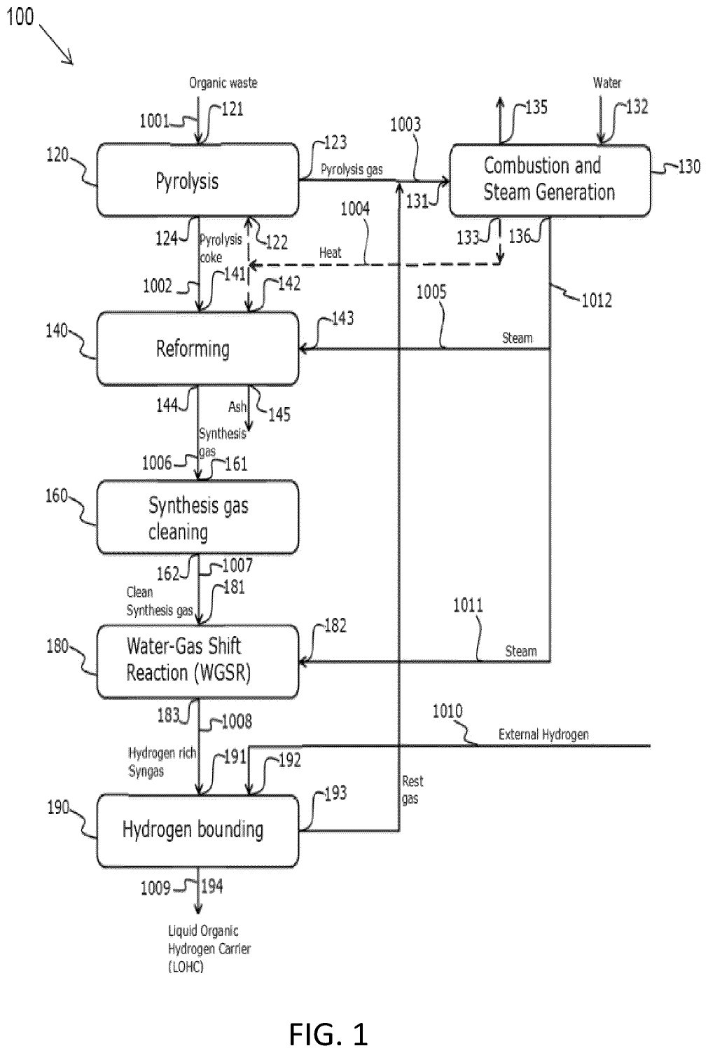

FIG. 1 is a drawing that schematically illustrates a facility 100 for storing hydrogen in an organic liquid provided as a Liquid Organic Hydrogen Carrier (LOHC). The hydrogen can be comprised in a mixture of gases comprising gaseous hydrogen and other gases. Gaseous hydrogen as produced in the process, in some embodiments, is pure, while in some embodiments the hydrogen can comprise further elements. In some embodiments, the gaseous hydrogen comprises traces of other material, liquid and/or gas.

In some embodiments, the facility 100 comprises an absorption chamber 190 configured to perform hydrogen bounding. In some embodiments, the facility 100 further comprises a reactor 180 configured to perform a Water-Gas Shift Reaction.

In some embodiments, the facility 100 further comprises a first endothermic chamber 120 configured to perform pyrolysis and a second endothermic chamber 140 configured to perform reformation to produce synthesis gas as described in detail below. In some embodiments, the facility 100 further comprises an exothermic chamber 130 configured for combustion to produce heat for use generation of steam. At least one effect can be that the synthesis gas flows into the absorption chamber. Another effect can be that the LOHC present in the absorption chamber extracts hydrogen from the synthesis gas. Other gaseous components of the synthesis gas may flow out of the absorption chamber as a rest gas. Thus, drawbacks associated with the extraction of hydrogen by PSA and then performing the LOHC bounding can be mitigated.

In some embodiments, the first endothermic chamber 120 is adapted to have the feedstock perform endothermic breakdown reactions to produce thermally-decomposed feedstock. In some embodiments, the first endothermic chamber 120 is configured as a pyrolysis chamber of the facility 100. In some embodiments, the first endothermic chamber 120 is configured to operate at a temperature of equal to or above 60° C. In some embodiments, the first endothermic chamber 120 is configured to operate at a temperature of equal to or above 100° C. In some embodiments, the first endothermic chamber 120 is configured to operate at a temperature of equal to or above 160° C. At least one effect can be that the first chamber can subject sugar to the pyrolysis. In some embodiments, the first endothermic chamber 120 is configured to operate at a temperature of equal to or above 200° C., for example in a temperature range of from 200 ° C. to 600° C. or in a temperature range of from 200° C. to at least up to 300° C. In some embodiments, the first endothermic chamber 120 is configured to operate at a temperature of equal to or above 350° C., for example in a temperature range of from 350° C. to 600° C. At least one effect can be that feedstock fed to the first endothermic chamber 120 in operation of the first endothermic chamber 120 breaks down into pyrolysis products, i.e., a pyrolysis gas and/or a pyrolysis coke. In some embodiments, the first endothermic chamber 120 is adapted to operate at the temperature of at least 350° C. The decomposition works under the exclusion of oxygen. At least one effect can be that the feedstock is thermally decomposed.

In some embodiments, the first endothermic chamber 120 is adapted to thermally decompose the feedstock into a gaseous stream, like pyrolysis gas. In some embodiments, the first endothermic chamber 120 is adapted to thermally decompose the feedstock into a solids stream, like pyrolysis coke.

In some embodiments, the first endothermic chamber 120 comprises a first pyrolysis inlet 121. In some embodiments, the first pyrolysis inlet 121 is adapted to receive the feedstock that comprises biodegradable waste. In an embodiment, the feedstock essentially consists of biodegradable waste. In some embodiments, the first endothermic chamber 120 comprises a heating device (not shown). The heating device can be configured to provide thermal energy to support endothermic breakdown reactions in the first endothermic chamber 120. In some embodiments, the first endothermic chamber 120 further comprises a second pyrolysis inlet 122. In some embodiments, the second pyrolysis inlet 122 is adapted to receive process heat to support endothermic breakdown reactions in the first endothermic chamber 120. In some embodiments, the second pyrolysis inlet 122 is adapted to receive process heat from the exothermic chamber 130. Thus, the first endothermic chamber 120 is adapted to perform breakdown reactions on the feedstock, whereby thermally decomposed feedstock can be produced.

In some embodiments, the first endothermic chamber 120 further comprises a first pyrolysis outlet 123. In some embodiments, the first pyrolysis outlet 123 is configured to release pyrolysis gas for use in the exothermic chamber 130. In some embodiments, the first endothermic chamber 120 further comprises a second pyrolysis outlet 124. In some embodiments, the second pyrolysis outlet 124 is configured to release pyrolysis coke for use in the second exothermic chamber 140. At least one effect can be that pyrolysis products can be released to be used in the second endothermic chamber 140 and to be used in the combustion chamber 130.

In some embodiments, the second endothermic chamber 140 is adapted to receive the thermally decomposed feedstock from the first endothermic chamber 120. In some embodiments, the second endothermic chamber 140 is adapted to produce a synthesis gas by performing an allothermal gasification process on a combination of the thermally-decomposed feedstock and steam, herein referred to as first steam.

In some embodiments, the second endothermic chamber 140 is adapted to perform an allothermal gasification process on the thermally decomposed feedstock to produce the synthesis gas. In some embodiments, the second endothermic chamber 140 is adapted to produce a synthesis gas. The second endothermic chamber 140 is adapted to operate at the temperature above 600° C., for example, at least at 700° C. In some embodiments, the second endothermic chamber 140 is a reformer. At least one effect can be that a synthesis gas is produced from the thermally decomposed feedstock. The synthesis gas, in turn, can be used in a production of hydrogen.

In some embodiments, the second endothermic chamber 140 comprises a first reformer inlet 141. In some embodiments, the first reformer inlet 141 is adapted to receive the thermally decomposed feedstock. In some embodiments, the first reformer inlet 141 is adapted to receive the thermally decomposed feedstock from the first endothermic chamber 120 as pyrolysis coke. At least one effect can be that the pyrolysis coke is available for use in the reformation process.

In some embodiments, the second endothermic chamber 140 further comprises a second reformer inlet 142. In some embodiments, the second reformer inlet 142 is configured to receive process heat. In some embodiments, the second reformer inlet 142 is configured to receive process heat from the exothermic chamber 130.

In some embodiments, the second endothermic chamber 140 further comprises a third reformer inlet 143. In some embodiments, the third reformer inlet 143 is configured to receive steam. In some embodiments, the second endothermic chamber 140 is configured to receive the steam produced with heat from the exothermic chamber 130. At least one effect can be that that the second endothermic chamber 140 can perform an allothermal gasification process on the thermally-decomposed feedstock using the process heat and steam.

In some embodiments, the second endothermic chamber 140 further comprises a first reformer outlet 144. In some embodiments, the first reformer outlet 144 is adapted to release synthesis gas. In some embodiments, the first reformer outlet 144 is adapted to discharge the synthesis gas from the second endothermic chamber 140.

In some embodiments, the second endothermic chamber 140 further comprises a second reformer outlet 145. In some embodiments, the second reformer outlet 145 is adapted to release leftover coke of the reforming process from the second endothermic chamber 140. In some embodiments, the second reformer outlet 145 is adapted to release ash from the second endothermic chamber 140. At least one effect can be that the second endothermic chamber 140 is cleaned.

In some embodiments, the exothermic chamber 130 is adapted to produce process heat. In some embodiments, the exothermic chamber 130 is further adapted to produce process steam. In some embodiments, the first steam comprises a first portion of the process steam.

In some embodiments, the process heat is produced by combusting the pyrolysis gas inside the exothermic chamber 130. The exothermic chamber 130 is adapted to operate at the temperature of above 700° C., such as at least at 1300° C. At least one effect can be to generate process heat inside the facility that is available for thermal decomposition of the feedstock to produce thermally decomposed feedstock. In turn, the thermally decomposed feedstock can be used in a production of the synthesis gas from the thermally decomposed feedstock. In some embodiments, the exothermic chamber 130 is further adapted to produce steam from water. Another effect can be that steam is generated for the production of the synthesis gas from the thermally decomposed feedstock and for the reactor.

In some embodiments, the exothermic chamber 130 includes a combustion zone. In some embodiments, the exothermic chamber 130 is configured to combust a variety of fuels. The combustion zone of the exothermic chamber may be configured as a multi-fuel combustion zone capable of receiving and combusting the variety of fuels and/or configured with a multi-fuel burner. Thus, the variety of fuels can be selectively provided to the combustion zone of the exothermic chamber 130. For example, the feedstock includes solid phase feedstock and/or gaseous/vaporized phase feedstock. Thus, the exothermic chamber 130 can be used to perform combustion on any phase of feedstock, thereby reducing, for example, a need for additional fuel for combustion.

In some embodiments, the exothermic chamber 130 comprises a first combustion inlet 131. In some embodiments, the first combustion inlet 131 is adapted to receive the thermally decomposed feedstock. In some embodiments, the first combustion inlet 131 is adapted to receive the thermally decomposed feedstock from the first endothermic chamber 120. In some embodiments, the first combustion inlet 131 is adapted to receive the pyrolysis gas from the endothermic chamber 120. In some embodiments, the exothermic chamber 130 further comprises a second combustion inlet 132. In some embodiments, the second combustion inlet 132 is configured to receive water. At least one effect can be that that the exothermic chamber 130 is capable of producing both, steam and process heat.

In some embodiments, the exothermic chamber 130 further comprises a process heat outlet 133. In some embodiments, the process heat outlet 133 is adapted to release process heat. In some embodiments, the process heat outlet 133 is adapted to release process heat from the exothermic chamber 130 to the first endothermic chamber 120. In some embodiments, the process heat outlet 133 of the exothermic chamber 130 is further adapted to release process heat from the exothermic chamber 130 to the second endothermic chamber 140. In some embodiments, the exothermic chamber 130 further comprises a an exhaust outlet 135. In some embodiments, the exhaust outlet 135 is adapted to discharge exhaust gas from the exothermic chamber 130 after combustion. In some embodiments, the exothermic chamber 130 further comprises a steam outlet 136. In some embodiments, the steam outlet 136 is adapted to release steam from the exothermic chamber 130 to the second endothermic chamber 140 and/or from the exothermic chamber 130 to the reactor 180.

In some embodiments, the exothermic chamber 130 further comprises a steam generator. At least one effect can be that that the exothermic chamber 130 produces steam for the reformation process and for the Water gas shift reaction in the reactor.

In some embodiments, the facility 100 further comprises a plurality of conduits. In some embodiments, the plurality of conduits is configured to couple the first endothermic chamber 120, the second endothermic chamber 140, the exothermic chamber 130, the reactor 180 and the absorption chamber 190 to one another, respectively. For example, a set of conduits of the plurality of conduits is implemented as a tube configured to have a gas flow through the tube. In some embodiments, the tube is configured for flow of pressurized gas. At least one effect can be that, depending on the respective pressure gradients between coupled chambers, hot gas flows between the first endothermic chamber 120, the second endothermic chamber 140, the exothermic chamber 130, the reactor 180 and the absorption chamber 190. For another example, another set of conduits of the plurality of conduits is implemented as a conveyer belt configured to transport solids thereon.

In some embodiments, the plurality of conduits comprises an organic waste conduit 1001. In some embodiments, the organic waste conduit 1001 is configured to receive feedstock for transport to the first reformer inlet 121, for example, the organic waste conduit is configured to receive organic waste for feeding the organic waste through the first reformer inlet 121 into the first endothermic chamber 120.

In some embodiments, the plurality of conduits comprises a coke conduit 1002. In some embodiments, the coke conduit 1002 is configured to couple the second pyrolysis outlet 124 of the first endothermic chamber 120 to the first reformer inlet 141 of the second endothermic chamber 140. At least one effect can be that, in operation of the facility, the pyrolysis coke gets transported from the first endothermic chamber 120 to the second endothermic chamber 140.

In some embodiments, the plurality of conduits comprises a pyrolysis gas conduit 1003. In some embodiments, the pyrolysis gas conduit 1003 is configured to couple the first pyrolysis outlet 123 of the first endothermic chamber 120 to the first combustion inlet 131 of the exothermic chamber 130. At least one effect can be that, in operation of the facility, the pyrolysis gas flows from the first endothermic chamber 120 to the exothermic chamber 130.

In some embodiments, the plurality of conduits comprises a heat conduit 1004. In some embodiments, the heat conduit 1004 is configured to couple the process heat outlet 133 of the exothermic chamber 130 to the second pyrolysis inlet 122 of the first endothermic chamber 120. At least one effect can be that, in operation of the facility, the process heat flows from the exothermic chamber 130 to the first endothermic chamber 120.

In some embodiments, the heat conduit 1004 is configured to couple the process heat outlet 133 of the exothermic chamber 130 to the second reformer inlet 142 of the second endothermic chamber 140. At least one effect can be that the process heat flows from the exothermic chamber 130 to the second endothermic chamber 140. In some embodiments, the plurality of conduits comprises a reformer steam conduit 1005. In some embodiments, the reformer steam conduit 1005 is configured to couple the steam outlet 136 of the exothermic chamber 130 to the third reformer inlet 143 of the second endothermic chamber 140. At least one effect can be that, in operation of the facility, the steam generated by the exothermic chamber 130 flows into the second endothermic chamber 140. In some embodiments, the reformer steam conduit 1005 is configured for the first steam to flow into the second endothermic chamber 140.

In some embodiments, the facility 100 further comprises a gas cleansing chamber 160. The gas cleansing chamber 160 is adapted to cleanse product gas obtained after gasification from the second endothermic chamber 140, i.e., the synthesis gas. At least one effect can be that, in operation of the facility, the product gas or the synthesis gas obtained from the gasification process undergoes a cleansing process in the gas cleansing chamber 160 to obtained cleansed product gas. Thus, an amount of contaminants in cleansed product gas is reduced. For example, the cleansed product gas may be have a level of contaminants, such as particulates, sulfur, ammonia, carbon dioxide, chlorides, mercury and/or other trace metals, that is reduced when compared to a level of such contaminants in the product gas before undergoing the cleansing. Thus, the purity of the synthesis gas is thus improved. At least one effect can be an improved efficiency achieved in process steps that use the cleansed gas.

In some embodiments, the gas cleansing chamber 160 comprises at least one cleansing inlet 161. In some embodiments, the gas cleansing chamber 160 further comprises at least one cleansing outlet 162. At least one effect can be that the gas cleansing chamber 160 is in fluid communication with the second endothermic chamber 140 and the reactor 180. In operation of the facility, gas can flow via synthesis gas conduit 1006 from the reformer outlet 144 of the second endothermic chamber 140 to the cleansing inlet 161 of the cleansing chamber 160. Further, in operation of the facility 100, gas can flow from the cleansing outlet 162 of the cleansing chamber 160 via cleansed synthesis gas conduit 1007 to the first reactor inlet 181 of the reactor 180.

In some embodiments, the reactor 180 is provided as a water-gas shift reactor (WGSR) that is adapted to perform a Water-Gas Shift Reaction (WGSR) on the cleansed product gas obtained from the gas cleansing chamber 160, whereby hydrogen-rich synthesis gas is obtained. At least one effect can be that the concentration of hydrogen in a WGSR cleansed product gas is increased when compared with a concentration of hydrogen in the cleansed product gas. In an alternative embodiment, the reactor 180 is adapted to perform a Water-Gas Shift Reaction (WGSR) directly on the product gas obtained from the second chamber 140. At least one effect can be that a concentration of hydrogen in a WGSR product gas is increased when compared with a concentration of hydrogen in the product gas.

In some embodiments, the reactor 180 is adapted to produce a hydrogen-rich synthesis gas by performing a Water-Gas Shift Reaction (WGSR) on the synthesis gas. In some embodiments, the reactor 180 is adapted to produce a hydrogen-rich synthesis gas by performing a Water-Gas Shift Reaction (WGSR) on a combination of, one, the synthesis gas or the cleansed synthesis gas and, two, steam, herein referred to as second steam. In some embodiments, the second steam comprises a second portion of the process steam. The hydrogen rich synthesis gas may be used for fuel synthesis. The reactor 180 is adapted to operate at the temperature of at least 250° C. In the WGSR, the carbon monoxide content of the synthesis gas with added steam to form carbon dioxide and additional hydrogen.

In some embodiments, the reactor 180 comprises a first reactor inlet 181. In some embodiments, the first reactor inlet 181 is adapted to receive the synthesis gas. In another embodiment, the first reactor inlet 181 is adapted to receive the cleansed synthesis gas. In some embodiments, the reactor 180 further comprises a second reactor inlet 182. In some embodiments, the second reactor inlet 182 is adapted to receive steam. In some embodiments, the second reactor inlet 182 is adapted to receive steam from the exothermic chamber 130. At least one effect can be that, in operation of the facility, the reactor 180 performs a Water-Gas Shift Reaction (WGSR) on the synthesis gas or on the cleansed synthesis gas using the steam to obtain hydrogen-rich synthesis gas.

In some embodiments, the reactor 180 further comprises at least one reactor outlet 183. In some embodiments, the reactor outlet 183 is adapted to release the hydrogen-rich synthesis gas. At least one effect can be that, in operation of the facility, the hydrogen-rich synthesis gas released from the reactor 180 is rich in hydrogen when compared to the synthesis gas or the cleansed synthesis gas prior to performing the Water-Gas Shift Reaction (WGSR) thereon.

In some embodiments, the absorption chamber 190 is adapted to hold an organic liquid that absorbs the hydrogen-rich synthesis gas. In some embodiments, the absorption chamber 190 is further adapted to contain catalysts, like alumina supported Rhodium Rh and Palladium Pd catalysts. In some embodiments, the absorption chamber 190 is configured to be operated with the organic liquid, and optionally along with catalysts, held at atmospheric pressure inside the absorption chamber 190. In some embodiments, the absorption chamber 190 is adapted to receive synthesis gas. In some embodiments, the absorption chamber 190 is adapted to receive the hydrogen-rich synthesis gas to flow from the reactor 180 into the absorption chamber 190. The absorption chamber 190 is further configured to hold an organic liquid capable of being hydrogenated by hydrogen contained in the hydrogen-rich synthesis gas. In some embodiments, the organic liquid absorbs the synthesis gas, separates the hydrogen from other components of the synthesis gas and bounds the hydrogen to store the hydrogen in the organic liquid Thus, a liquid organic hydrogen carrier (LOHC) can be obtained while the hydrogen is separated from the synthesis gas. At least one effect can be that, in operation of the facility, the absorption chamber 190 performs bounding of hydrogen in the Liquid Organic Hydrogen Carrier (LOHC).

In some embodiments, the absorption chamber 190 comprises a first absorption inlet 191. In some embodiments, the first absorption inlet 191 is adapted to receive the hydrogen-rich synthesis gas. In some embodiments, the absorption chamber 190 comprises a second absorption inlet 192. In some embodiments, the second absorption inlet 192 is adapted to receive external hydrogen from an external source.

In some embodiments, the absorption chamber 190 further comprises a first absorption outlet 193. In some embodiments, the first absorption outlet 193 is adapted to release the other components of the synthesis gas from the organic liquid out of the absorption chamber 190. In some embodiments, the facility 100 is configured to add rest gas released from the absorption chamber 190 to the pyrolysis products released from the first endothermic chamber 120. At least one effect can be that the rest gas is re-used for combustion of the pyrolysis products in the exothermic chamber 130. In some embodiments, the absorption chamber 190 further comprises a second absorption outlet 194.

In some embodiments, the second absorption outlet 194 is adapted to release the Liquid Organic Hydrogen Carrier (LOHC) to a usage site. At least one effect can be that the LOHC is used for storage, transportation and utilization of hydrogen. When hydrogen is required, it can be discharged from the LOHC at the usage site.

In some embodiments, the plurality of conduits comprises a synthesis gas conduit 1006. In some embodiments, the synthesis gas conduit 1006 is configured to couple the reformer outlet 144 of the second endothermic chamber 140 to the cleaning inlet 161 of the gas cleaning chamber 160. At least one effect can be that the synthesis gas flows from the second endothermic chamber 140, via the synthesis gas conduit 1006, to the gas cleansing chamber 160. In an alternative embodiment, the synthesis gas conduit 1006 is configured to couple the reformer outlet 144 of the second endothermic chamber 140 to the first reactor inlet 181 of the reactor 180. At least one effect can be that the synthesis gas flows directly from the second endothermic chamber 140 to the reactor 180.

In some embodiments, the plurality of conduits comprises a cleansed synthesis gas conduit 1007. In some embodiments, the cleansed synthesis gas conduit 1007 is configured to couple the cleaning outlet 162 of the cleaning chamber 160 to the first reactor inlet 181 of the reactor 180. At least one effect can be that the synthesis gas flows from the cleaning chamber 160, via the cleansed synthesis gas conduit 1007, to the reactor 180.

In some embodiments, the plurality of conduits comprises a hydrogen-rich gas conduit 1008. In some embodiments, the hydrogen-rich gas conduit 1008 is configured to couple the reactor outlet 183 of the reactor 180 to the first absorption inlet 191 of the absorption chamber 190. At least one effect can be that the hydrogen rich synthesis gas flows from the reactor 180, via the hydrogen-rich gas conduit 1008, to the absorption chamber 190.

In some embodiments, the plurality of conduits comprises a steam conduit 1011. In some embodiments, the steam conduit 1011 is configured to couple the steam outlet 136 of the combustion chamber 130 to the second reactor inlet 182 of the reactor 180. At least one effect can be that steam flows from the combustion chamber 130, via the steam conduit 1011, to the reactor 180. In some embodiments, the steam conduit 1011 is configured for the second steam to flow into the reactor 180.

In some embodiments, the plurality of conduits comprises an external hydrogen conduit 1010. In some embodiments, the external hydrogen conduit 1010 is configured for the absorption chamber 190 to receive external hydrogen in the second absorption inlet 192. In some embodiments, the plurality of conduits comprises an LOHC conduit 1009. In some embodiments, the LOHC conduit 1009 is configured to discharge the liquid organic hydrogen carrier from the absorption chamber 190 for storage to a reservoir (not shown) or for transport to a filling station (not shown) or to another LOHC processing apparatus (not shown).

In some embodiments, the plurality of conduits comprises another steam conduit 1012. In some embodiments, the another steam conduit 1012 is configured to couple the steam outlet 136 of the combustion chamber 130 to the reformer steam conduit 1005. In some embodiments, the another steam conduit 1012 is configured to couple the steam outlet 136 of the combustion chamber 130 to the steam conduit 1011. In some embodiments, the another steam conduit 1012 is configured to be distribute the steam between the reformer steam conduit 1005 and the steam conduit 1011 as the first steam in the reformer steam conduit 1005 and the second steam in the steam conduit 1011.

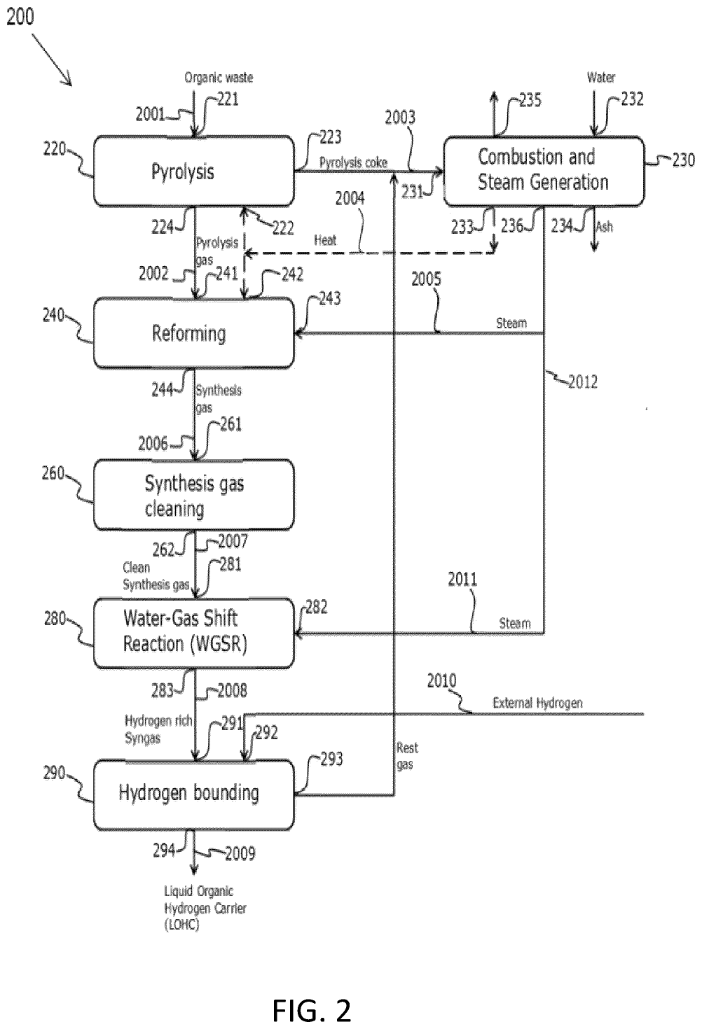

FIG. 2 is a drawing that schematically illustrates another variant of the facility 200 for storing the hydrogen into an organic compound, as described above with respect to the first embodiment. In some embodiments, the hydrogen production facility 200 comprises a reactor 280 and an absorption chamber 290. In some embodiments, the hydrogen production facility 200 further comprises a first endothermic chamber 220 and a second endothermic chamber 240. In some embodiments, the facility 200 further comprises an exothermic chamber 230 configured to produce at least steam. At least one effect can be that producing synthesis gas, extracting hydrogen and storing the hydrogen in an LOHC take place within a single facility.

The differences between embodiments according to the first variant according to the invention and embodiments according to the second variant according to the invention are described below.

For the sake of efficiency, when describing the second variant, where structural elements of the second variant are as in the above-described first variant, a description of these structural elements and their functions is forgone.

Like reference numerals are used throughout the description to denote features that are the same in the first variant and in the second variant. For example, first endothermic chamber 120 in the first variant is given reference numeral 220 in the second variant of the invention.

Instead of pyrolysis gas that, according to the first variant, flows from the first endothermic chamber 120 to the exothermic chamber 130, in the second variant, pyrolysis coke is transported from the first endothermic chamber 220 to the exothermic chamber 230. Further, instead of pyrolysis coke that, according to the first variant, is transported from the first endothermic chamber 120 to the second endothermic chamber 140, in the second embodiment, pyrolysis gas flows from the first endothermic chamber 220 to the second endothermic chamber 240. Accordingly, in the second variant, the exothermic chamber 230 is provided with pyrolysis coke and the second endothermic chamber 240 is provided with pyrolysis gas. At least one effect can be that the system (100) is implementable in a variety of existing facilities that produce synthesis gas. For example, the system (100) is implementable in facilities having provisions to produce the synthesis gas either by combusting pyrolysis coke and gasifying pyrolysis gas, or by combusting pyrolysis gas and gasifying pyrolysis coke. Thus, a conventional plant can be upgraded to implement the present system (100).

In some embodiments, the first pyrolysis outlet 223 of the first endothermic chamber 220 is configured to release pyrolysis coke for use in the exothermic chamber 230. In some embodiments, the second pyrolysis outlet 224 of the first endothermic chamber 220 is configured to release the pyrolysis gas for use in the second exothermic chamber 240. At least one effect can be that the pyrolysis products can be released to be used in the second endothermic chamber 240 and to be used in the combustion chamber 230.

In some embodiments, the first reformer inlet 241 of the second endothermic chamber 240 is adapted to receive the thermally decomposed feedstock from the first endothermic chamber 220 as pyrolysis gas. At least one effect can be that the pyrolysis gas is used for the reformation process.

In some embodiments, the first combustion inlet 231 of the exothermic chamber 230 is adapted to receive the pyrolysis coke from the first endothermic chamber 220. In some embodiments, the exothermic chamber 230 further comprises a fourth combustion outlet 234. The fourth combustion outlet 234 is adapted to release ash from the exothermic chamber 230. At least one effect can be that the exothermic chamber 230 is cleaned.

As described with respect to the first variant, the facility 200 further comprises a plurality of conduits. In some embodiments, the plurality of conduits comprises a pyrolysis gas conduit 2002. In some embodiments, the pyrolysis gas conduit 2002 is configured to couple the second pyrolysis outlet 224 of the first endothermic chamber 220 to the first reformer inlet 241 of the second endothermic chamber 240. At least one effect can be that, in operation of the facility, the pyrolysis gas flows from the first endothermic chamber 220 to the second endothermic chamber 240.

In some embodiments, the plurality of conduits comprises a pyrolysis coke conduit 2003. In some embodiments, the pyrolysis coke conduit 2003 is configured to couple the first pyrolysis outlet 223 of the first endothermic chamber 220 to the first combustion inlet 231 of the exothermic chamber 230. At least one effect can be that, in operation of the facility, the pyrolysis coke gets transported from the first endothermic chamber 220 to the exothermic chamber 230.

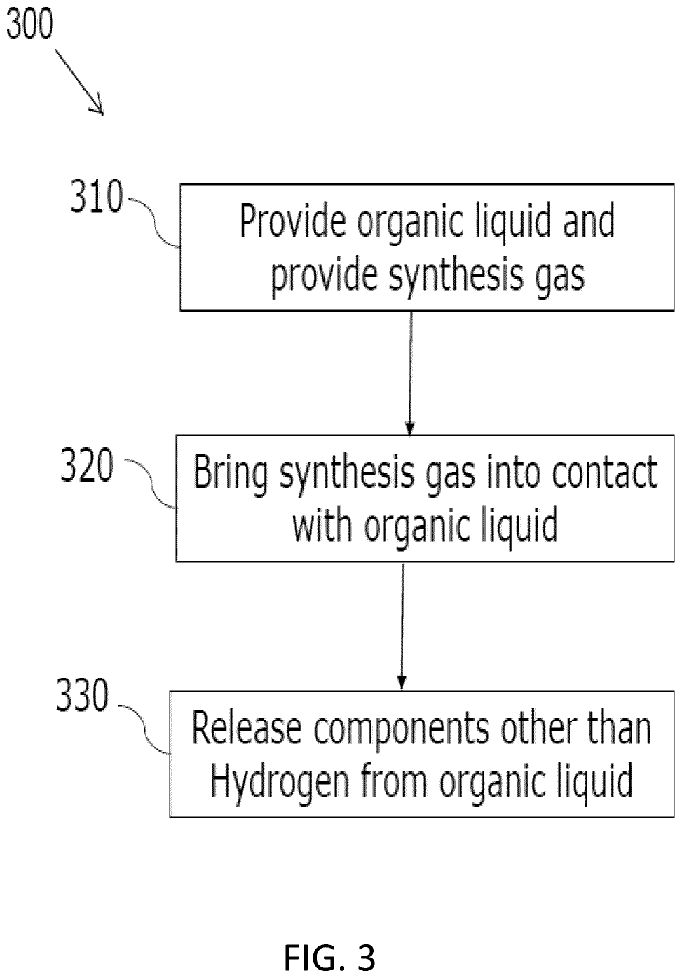

According to another aspect of the invention, a method 300 for storing hydrogen in an organic liquid, such as the Liquid Organic Hydrogen Carrier (LOHC), is disclosed. Below, an embodiment of the method will be described with reference to FIG. 3. For example, the method 300 can implemented in a hydrogen production facility such as the hydrogen production facility 100 or the hydrogen production facility 200 described above. Therefore, below, reference will also be made to components of the hydrogen production facility 100 described above. However, it should be understood that the method can be implemented in any other facility provided that the facility is adapted to perform the method by having functional components to perform steps of the method as described.

The method 300 comprises performing an endothermic reaction for thermal decomposition of feedstock to produce a pyrolysis product. In some embodiments, feedstock present in a hydrogen production facility, for example, the hydrogen production facility 100 described above, is provided, based on the suitability, to any of the first endothermic chamber 120, second endothermic chamber 140 and/or the exothermic chamber 130.

In some embodiments, the feedstock is provided to the first endothermic chamber 120 by means of a conveying system from a storage to the hydrogen production facility 100. The method 300 further comprises a step (not shown in FIG. 3) of performing an endothermic reaction on the feedstock. Thus, thermal decomposition of the feedstock produces a pyrolysis product. For example, the endothermic decomposition of the feedstock is performed in the first endothermic chamber 120. In some embodiments, the thermal decomposition of feedstock is performed under controlled conditions, including but not limited to controlling the temperature of the endothermic reaction. In some embodiments, the thermal decomposition of feedstock is performed at a temperature of equal to or above 60° C. In some embodiments, the thermal decomposition of feedstock is performed at a temperature of equal to or above 100° C. In some embodiments, the thermal decomposition of feedstock is performed at a temperature of equal to or above 160° C. At least one effect can be that the first chamber can subject sugar to the pyrolysis. In some embodiments, the thermal decomposition of feedstock is performed at a temperature of equal to or above 200° C., for example in a temperature range of from 200° C. to 600° C. or in a temperature range of from 200° C. to at least up to 300° C. In some embodiments, the thermal decomposition of feedstock is performed at a temperature of equal to or above 350° C., for example in a temperature range of from 350° C. to 600° C. At least one effect can be that feedstock fed, for example, to the first endothermic chamber 120 in operation of the first endothermic chamber 120 breaks down into pyrolysis products. In some embodiments, the pyrolysis product comprises a pyrolysis gas and a pyrolysis coke.

The method further comprises performing a step (not shown in FIG. 3) comprising an allothermal gasification of a combination of the pyrolysis product with first steam to produce a synthesis gas. Thus, in some embodiments, the allothermal gasification process comprises a reformation process. In some embodiments, the method comprises performing the allothermal gasification on a combination of the thermally decomposed feedstock, obtained in the hydrogen production facility 100, with first steam to produce synthesis gas. In some embodiments, the feedstock, in the thermally decomposed state, suitable for reforming, is provided directly to the second endothermic chamber 140 by means of a conveying system from the storage to the hydrogen production facility 100. In some embodiments, the method comprises performing the allothermal gasification process, to produce a synthesis gas, on a combination of the pyrolysis product, obtained from the endothermic reaction, with first steam, and the thermally decomposed feedstock obtained from the hydrogen production facility 100. In some embodiments, the allothermal gasification process is performed at a temperature above 600° C., for example, at least at 700° C. At least one effect can be that synthesis gas is produced from the thermally decomposed feedstock. The synthesis gas, in turn, can be used in a production of hydrogen.

In a variant implementation, the method comprises combusting the pyrolysis product to generate combustion heat. In some embodiments, the method comprises combusting feedstock which is suitable for combustion, obtained from the hydrogen production facility, to generate combustion heat. In some embodiments, the method comprises combusting a combination of the pyrolysis product obtained after the thermal decomposition of feedstock and the feedstock suitable for combustion obtained, for example, from the hydrogen production facility 100. In some embodiments, combusting includes combusting a variety of fuels to generate combustion heat. In some embodiments, the combustion process takes place at a temperature of above 700° C., such as at least at 1300° C. At least one effect can be to generate process heat inside the facility that is available for thermal decomposition of the feedstock to produce thermally decomposed feedstock.

In some embodiments, the method further comprises using the combustion heat to generate process steam from water. One effect can be that the generated steam is used in the production of the synthesis gas. For example, the reactor 180 can receive the generated steam to perform a Water-Gas Shift Reaction (WGSR) on the synthesis gas. In some embodiments, as described above with reference to FIG. 2, the reactor 180 receives the generated steam to perform a Water-Gas Shift Reaction (WGSR) on the cleansed synthesis gas. Thus, the generated steam can be used in a process step to obtain hydrogen-rich synthesis gas.

In some embodiments, the method comprises providing a first portion of the process steam as the first steam for use in the allothermal gasification process, and/or providing a second portion of the process steam as the second steam for use in the Water-Gas Shift Reaction.

In some embodiments, the method comprises providing the pyrolysis coke comprised in the pyrolysis product for combustion. Further, in some embodiments, the method comprises providing pyrolysis gas from the pyrolysis product for reformation. For example, accordingly, in some embodiments, the method comprises controlling and/or varying pyrolysis products that flow from the first endothermic chamber 120 to the second endothermic chamber 140 and to the exothermic chamber 130. As a consequence, the combustion process, in some embodiments, combusts pyrolysis coke comprised in the pyrolysis product, and, the combustion process, in some embodiments, combusts pyrolysis gas from the pyrolysis product. Likewise, in embodiments where the combustion process combusts pyrolysis coke, the reforming process uses pyrolysis gas from the pyrolysis product for gasification, and in embodiments where the combustion process combusts pyrolysis gas, the reforming process uses pyrolysis coke from the pyrolysis product for gasification.

At least one effect can be that the pyrolysis coke is combusted and the pyrolysis gas is gasified to produce synthesis gas. When the pyrolysis coke is used for combustion, in some embodiments, the method comprises discharging ash after combustion of the pyrolysis coke from the combustion chamber. Thus, the combustion chamber is cleaned.

In some embodiments, the method comprises providing the pyrolysis gas from the pyrolysis product for combustion and the pyrolysis coke from the pyrolysis product for reformation. At least one effect can be that the pyrolysis gas is combusted and the pyrolysis coke is gasified to produce synthesis gas. When the pyrolysis coke is used for reformation, the method comprises discharging ash after gasification of the pyrolysis coke from the reformer. Thus, the reformer is cleaned.

In some embodiments, the method further comprises regulating a purity level of hydrogen-rich synthesis gas. The method of regulating the purity level of the hydrogen-rich synthesis gas includes but is not limited to cleansing the produced synthesis gas before the produced synthesis gas undergoes reformation to produce a hydrogen-rich synthesis gas.

In some embodiments, the method comprises performing a Water-Gas Shift Reaction (WGSR) on the synthesis gas. In some embodiments, the method comprises performing a Water-Gas Shift Reaction (WGSR) on a combination of the synthesis gas with second steam. At least one effect can be that the hydrogen-rich synthesis gas is produced.

In some embodiments, the method comprises cleaning the synthesis gas in a gas cleaning system to produce a clean synthesis gas. The method further comprises performing the Water-Gas Shift Reaction (WGSR) on the cleansed synthesis gas to produce a cleansed hydrogen-rich synthesis gas. The method further comprises performing WGSR on the cleansed synthesis gas with the second steam to produce a cleansed hydrogen-rich synthesis gas. At least one effect can be that the purity level of the hydrogen-rich synthesis gas is increased. The method further comprises storing the cleansed hydrogen-rich synthesis gas in an organic liquid. At least one effect can be that the hydrogen is extracted from the synthesis gas, and the extracted hydrogen is stored in the LOHC.

The method, at step 310, comprises bringing synthesis gas into contact with organic liquid. For example, in some embodiments, the synthesis gas is introduced into the absorption chamber 290 which holds the organic liquid such as Liquid Organic Hydrogen Carrier (LOHC). Thus, at step 320, the organic liquid absorbs the synthesis gas. Further, the method comprises, at step 330, having the organic liquid separate the hydrogen from other components of the synthesis gas and bound the hydrogen to store the hydrogen in the organic liquid.

In some embodiments, the method further comprises releasing the other components of the synthesis gas from the organic liquid as rest gas from the absorption chamber. At least one effect can be that the rest gas is re-used at least for combustion.

In some embodiments, the method comprises adding hydrogen from an external source to the hydrogen-rich synthesis gas. The method further comprises combusting the pyrolysis product to heat water for generating steam.

Although specific embodiments have been illustrated and described herein, it will be appreciated by those of ordinary skill in the art that a variety of alternate and/or equivalent implementations may be substituted for the specific embodiments shown and described without departing from the scope of the present invention. This application intends to cover any adaptations or variations of the specific embodiments discussed herein. For example, while in the examples illustrated in FIG. 1 and in FIG. 2 the hydrogen production facility comprises a gas cleaning chamber, in another example (not shown) the hydrogen production facility is without the gas cleaning chamber.

As used herein the term ‘facility’ comprises implementations as a system, an apparatus, a collection of apparatus that together form a system, a arrangement of components that are configured to cooperate as disclosed herein with respect to the facility; in some embodiments, at least some of the components are co-located while in some embodiments one or more of the components are separated from other components by a distance larger than necessitated from a functional point of view. For example, one component of the facility can be provided in a first municipality or district, while other components of the facility are provided in a second municipality or district.

As used herein, storing the hydrogen into an organic compound′ means to comprise absorbing hydrogen, in particular, hydrogen molecules or hydrogen atoms in a Liquid Organic Hydrogen Carrier (LOHC).

The implementations herein are described in terms of exemplary embodiments. However, it should be appreciated that individual aspects of the implementations may be separately claimed and one or more of the features of the various embodiments may be combined. For example, the features of the invention explained in terms of a hydrogen production facility according to an aspect of the invention, such features, as far the person skilled in the art could relate, also extend to the process of the hydrogen production according to another aspect of the invention, and vice versa.

### Reference Numerals

Facility 100, 200;
First endothermic chamber 120, 220;
Second endothermic chamber 140, 240;
Reactor 180, 280;
Absorption chamber 190, 290;
Exothermic chamber 130, 230;
First pyrolysis inlet 121, 221;
Second pyrolysis inlet 122, 222;
First pyrolysis outlet 123, 223;
Second pyrolysis outlet 124, 224;
First reformer inlet 141, 241;
Second reformer inlet 142, 242;
Third reformer inlet 143, 243;
First reformer outlet 144, 244;
Second reformer outlet 145;
First combustion inlet 131, 231;
Second combustion inlet 132, 232;
Process heat outlet 133, 233;
Fourth combustion outlet 234
Exhaust outlet 135, 235;
Steam outlet 136, 236;
Organic waste conduit 1001, 2001;
Coke conduit 1002, Pyrolysis gas conduit 2002;
Pyrolysis gas conduit 1003, Coke conduit 2003;
Heat conduit 1004, 2004;
Reformer steam conduit 1005, 2005;
Gas cleansing chamber 160, 260;
Cleansing inlet 161, 261;
Cleansing outlet 162, 262;
First reactor inlet 181, 281;
Second reactor inlet 182, 282;
Reactor outlet 183, 283;
First absorption inlet 191, 291;
Second absorption inlet 192, 292;
First absorption outlet 193, 293;
Second absorption outlet 194, 294;
Synthesis gas conduit 1006, 2006;
Cleansed synthesis gas conduit 1007, 2007;
Hydrogen-rich gas conduit 1008, 2008;
LOHC conduit 1009, 2009;
External hydrogen conduit 1010, 2010; and
Steam conduits 1011, 1012, 2011, 2012.

1. A facility for storing hydrogen in an organic liquid, the facility comprising:
an absorption chamber adapted:
to hold the organic liquid,
to receive synthesis gas and bring the synthesis gas in contact with the organic liquid whereby the organic liquid can absorb a portion of the synthesis gas, separate the hydrogen from other components of the absorbed synthesis gas and bound separated hydrogen to store bound separated hydrogen in the organic liquid, and
to release the other components of the absorbed synthesis gas from the organic liquid.

2. The facility of claim 1, further comprising: a reactor adapted to perform a Water-Gas Shift Reaction, WGSR, on the synthesis gas to produce a hydrogen-rich synthesis gas; wherein the absorption chamber is adapted to receive the hydrogen-rich synthesis gas from the reactor.

3. The facility of claim 2, wherein the reactor is adapted to perform the WGSR on a combination of the synthesis gas and second steam to produce the hydrogen-rich synthesis gas.

4. The facility of any one of claim 1, further comprising: a first endothermic chamber adapted to have feedstock perform endothermic break-down reactions to produce thermally-decomposed feedstock; and a second endothermic chamber adapted to produce the synthesis gas by performing an allothermal gasification process on a combination of the thermally-decomposed feedstock and first steam.

5. The facility of any one of claim 1, further comprising: an exothermic chamber adapted to produce process steam, wherein the first steam comprises a first portion of the process steam, and/or wherein the second steam comprises a second portion of the process steam.

6. The facility according to claim 5, wherein the first endothermic chamber is configured to receive process heat from the exothermic chamber.

7. The facility according to claim 5, wherein the second endothermic chamber is configured to receive the process heat from the exothermic chamber.

8. The facility according to claim 5, wherein the second endothermic chamber is configured to receive the first portion of the process steam from the exothermic chamber.

9. The facility according to claim 5, wherein the reactor is configured to receive the second portion of the process steam from the exothermic chamber

10. The facility according to claim 1, wherein the absorption chamber is configured to receive additional hydrogen from an external source.

11. The facility according to claim 3, wherein the second endothermic chamber is configured to receive coke from the first endothermic chamber.

12. The facility according to claim 5, wherein the exothermic chamber is configured to receive coke from the first endothermic chamber.

13. The facility according to claim 1, the facility further comprising a gas cleansing chamber adapted to cleanse the synthesis gas.

14. The facility according to claim 1, wherein the absorption chamber is configured to be operated with the organic liquid held at atmospheric pressure inside the absorption chamber

15. A method for storing hydrogen in an organic liquid, said method comprising:
providing the organic liquid and a synthesis gas comprising the hydrogen;
bringing the synthesis gas into contact with the organic liquid whereby the organic liquid can absorb a portion of the synthesis gas, separate the hydrogen from other components of absorbed synthesis gas and bound separated hydrogen to store bound hydrogen in the organic liquid; and
releasing the other components of the absorbed synthesis gas from the organic liquid.

16. The method according to claim 15, further comprising:
performing a Water-Gas Shift Reaction, WGSR, on the synthesis gas to produce a hydrogen-rich synthesis gas; wherein the having the organic liquid absorb the synthesis gas comprises having the organic liquid absorb at least a portion of the hydrogen-rich synthesis gas.

17. The method according to claim 16, further comprising:
performing an endothermic reaction for thermal decomposition of feedstock to produce a pyrolysis product; and
performing an allothermal gasification process on a combination of the pyrolysis product with first steam to produce the synthesis gas.

18. The method according to claim 16, further comprising: adding hydrogen from an external source to the hydrogen-rich synthesis gas.

19. The method according to claim 17, wherein the pyrolysis product comprises coke and wherein the allothermal gasification process is performed on the coke, or wherein the pyrolysis product comprises pyrolysis gas and wherein the allothermal gasification process is performed on the pyrolysis gas.

20. The method according to claim 17, further comprising: combusting the pyrolysis product to generate combustion heat, using the combustion heat to generate process steam from water, providing a first portion of the process steam as the first steam for use in the allothermal gasification process, and/or providing a second portion of the process steam as the second steam for use in the WGSR.
